(19) United States
(12) Patent Application Publication
(10) Pub. No.: US 2013/0040037 A1
(43) Pub. Date: Feb. 14, 2013

(54) PROTEIN BEVERAGE AND METHOD OF MANUFACTURE

(71) Applicants: Paul Shepherd, Spanish Fork, UT (US); Michael Shepherd, Spanish Fork, UT (US)

(72) Inventors: Paul Shepherd, Spanish Fork, UT (US); Michael Shepherd, Spanish Fork, UT (US)

(21) Appl. No.: 13/569,880

(22) Filed: Aug. 8, 2012

Related U.S. Application Data
(60) Provisional application No. 61/522,139, filed on Aug. 10, 2011.

(51) Int. Cl. A23L 2/66; A23L 2/60; A23J 3/04; A23L 2/56

(52) U.S. Cl. 426/593; 426/590

(57) ABSTRACT

A protein beverage includes at least 90 percent egg white and at least one of a flavoring and sweetener. The beverage may be made by mixing pasteurized egg whites with a flavoring sweetener, and/or other biological enhancing agent, homogenizing the mixture, re-pasteurizing the beverage, and then bottling the mixture.

### RELATED APPLICATIONS

The present application claims the benefit of U.S. Provisional Application Ser. No. 61/522,139, filed on Aug. 10, 2011, which is incorporated herein by reference in its entirety.

### BACKGROUND OF THE INVENTION

1. Field of the Invention

The present invention relates to a protein beverage. In particular, the present invention relates to a high protein, ready to drink beverage with low fat and cholesterol.

2. State of the Art

The use of protein drinks has become common among individuals who are health conscious, those who wish to maintain or build lean muscle mass, such as athletes, body builders, etc., and even the elderly. By providing high amounts of protein, these beverages help promote healthy muscles and can also help reduce obesity.

Protein-based drinks may be preferred over drinks that are comprised predominately of carbohydrates because of the role amino acids play in the building and repair of muscle tissue. For example, during exercise muscle tissue is often broken down. In order to rebuild and/or repair the muscle tissue, an individual must consume a sufficient amount of protein in order to provide the body with necessary amino acids. If the individual does not consume a sufficient amount of protein then he or she may experience a net loss in muscle mass.

In particular, athletes, bodybuilders, etc. may require a significantly high amount of protein to maintain or build muscle mass. It can be difficult and/or undesirable to obtain the necessary amount of protein to maintain or increase muscle mass from solid food sources. Moreover, consuming protein from solid food sources requires the body to first break down the food source so that the necessary amino acids are available in the body for rebuilding and repairing muscle. The timing of providing the body with available amino acids (e.g. before, during, or after strenuous exercise) plays an important role in maintaining and building muscle tissue. Thus, a protein-based drink may provide advantages over solid food protein sources because amino acids may be more readily available after consumption. Therefore, an athlete, body builder, etc. will often supplement his or her diet with a protein-based drink.

Many protein beverages available on the market include as a principal component whey protein which is derived from milk. Whey protein is relatively inexpensive and easy to obtain. Whey protein, however, often has a disfavored taste. Additionally, while whey-based protein drinks may be sold as ready to drink, they are most often sold as powders which are mixed with other liquids such as water, milk or orange juice to be consumed. The process of mixing the drink can be time consuming, messy, and often results in a drink which has chunks of un-dissolved drink mix. Additionally, drink mixes are often inconvenient because a person generally wants access to a protein drink immediately before, during, or after vigorous exercise.

Other protein drinks may use egg whites as a source of protein. Typically, protein drinks made from egg whites are sold as a dry mixture of egg white powder and other nutritional supplements and flavors. However, as with whey-based milk powders, the mixture must still be combined with water, milk, or some other beverage for drinking. The resulting beverage often has chunks of the mixture, especially if the person does not have ready access to a blender. Additionally, the process of drying the egg white typically heats up the egg white substantially and/or exposes the egg whites to heat for a prolonged period of time. The heat applied to the egg whites can denature the protein therein and reduce the bioavailability of the amino acids.

Although some people have attempted to mix raw egg whites with other beverages in order to increase protein content of the overall beverage, such a use may result in the overall beverage having less protein than is desired. Consuming raw egg whites alone is typically not palatable for many people. This is often due to both the consistency and taste of the egg whites. An additional concern with the use of egg whites is that egg whites are a good media for bacteria growth, including various pathogens such as salmonella. Thus, there are safety concerns when using egg whites in ready to drink products.

Thus, there is a desire to create a ready to drink beverage which is high in protein, pleasing to the taste, and which is safe to consume while having a reasonably long shelf life.

### SUMMARY OF THE INVENTION

The above and other objects of the invention are accomplished in a ready to drink protein beverage and method of making the same.

According to one aspect of the invention, a protein beverage may comprise at least 90% egg white and further includes at least one of a flavoring and a sweetener to thereby make the egg whites more palatable to drink.

In accordance with another aspect of the invention, a protein beverage may comprise at least 95% egg white and include both a flavoring and a sweetener.

In accordance with another aspect of the invention, a protein beverage comprises at least 99% egg white and include both flavoring and a sweetener.

In accordance with one aspect of the invention, a process for making a protein beverage may include the steps of: pasteurizing egg whites prior to the addition of flavoring(s) and/or sweetener(s) to the egg whites; adding flavoring(s) and/or sweetener(s) to the egg whites to form a mixture; and re-pasteurizing the mixture to reduce the likelihood of the flavoring(s) and/or sweeteners promoting bacterial growth.

In accordance with another aspect of the invention, the process for making a protein beverage may include the step of homogenizing a mixture of egg whites, flavoring(s) and/or sweeteners prior to a second pasteurization step to thereby increase consistency and flowability of the protein beverage.

In accordance with another aspect of the invention, a flavoring of a protein beverage may include cocoa powder which is liquefied to form a liquid or paste flavoring. Additional flavorings may also be combined with the liquefied cocoa powder. The flavoring liquid or paste may then be added to the pasteurized egg whites and homogenized to improve consistency and flowability.

In accordance with one aspect of the present invention, the process for making a protein beverage may include a first pasteurization run of egg whites at an elevated temperature of between about 137° Fahrenheit and 140° Fahrenheit prior to the addition of flavoring(s) and/or sweetener(s).

In accordance with another aspect of the invention, the process for making a protein beverage may include subjecting a mixture of egg whites, flavoring(s) and/or sweetener(s) to a second pasteurization run at an elevated temperature of between about 137° Fahrenheit and 140° Fahrenheit to thereby pasteurize the mixture without substantially denaturing protein in the egg whites.

An egg white based protein beverage of the present invention is a substantially homogenous mixture that is highly flowable and has a consistency similar to that of flavored milk, such as chocolate or strawberry milk, which one would buy in a grocery store. A one cup serving of a protein beverage made according to principles of the present invention may only have about 130 calories which is approximately ten percent less than a cup of whole milk. Unlike whole milk, however, the beverage may also contain about 26 grams of protein, virtually no cholesterol and no fat. Thus a low fat, low cholesterol beverage can be formed with a large amount of highly bioavailable protein. The beverage is easily drinkable without undesirable aftertaste and may be conveniently used by body builders, other athletes, and people who just want to increase their protein consumption with little inconvenience or other negatives often associated with protein consumption.

### BRIEF DESCRIPTION OF THE DRAWINGS

Various embodiments and features of target systems are shown and described in reference to the following numbered drawings:

FIG. 1 shows a process for forming a protein beverage in accordance with principles of the present invention;

FIG. 2 shows a more detailed process for forming a protein beverage in accordance with principles of the present invention.

FIG. 3 shows a process of forming a flavoring agent for use in the beverage; and

It will be appreciated that the drawings are illustrative and not limiting of the scope of the invention which is defined by the appended claims. The embodiments shown accomplish various aspects of the invention. It is appreciated that it is not possible to clearly show each element and aspect of an invention in a single figure, and as such, multiple figures are presented to separately illustrate the various details of the invention. Several aspects from different figures may be used in conjunction with one another in order to fully make and use the invention. Similarly, not every embodiment or application of the invention need accomplish all advantages discussed above.

### DETAILED DESCRIPTION

Various aspects of the invention, including the process for making a high protein beverage in accordance with the invention, are shown in the accompanying drawings, which include reference numerals referred to below, and provide details for understanding and practice by one skilled in the art. The drawings and descriptions are exemplary of various aspects of target systems and associated methods and are not intended to narrow the scope of the appended claims.

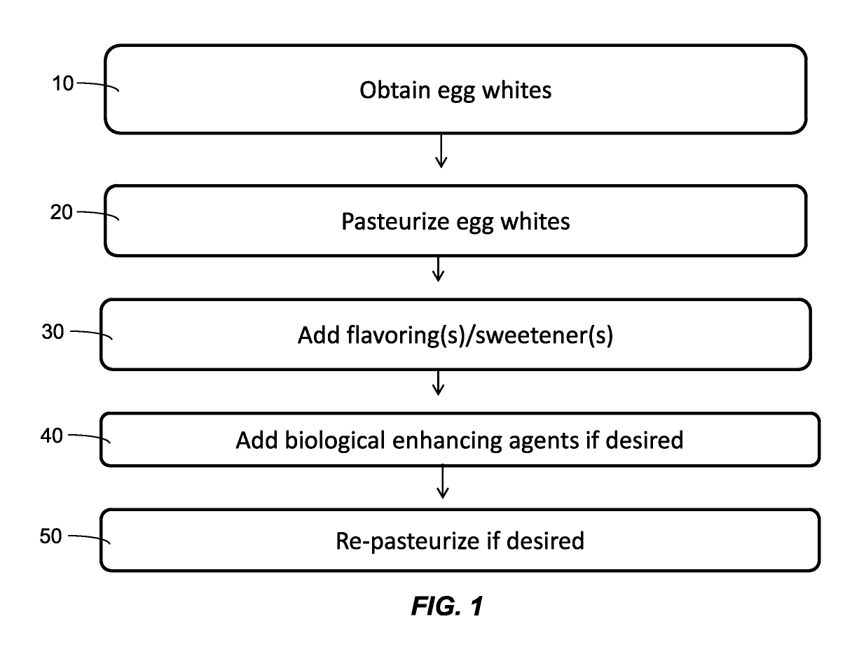

Turning now to FIG. 1, there is shown a process of making a protein beverage. The first step 10 comprises obtaining a quantity of liquid egg whites. This may be accomplished by cracking a number of eggs and separating the yolks, or, by simply purchasing liquid egg whites which are readily available from various egg processors.

A second step 20 may include pasteurizing the egg whites. Pasteurizing egg whites is typically done by heating the egg whites to a temperature for a sufficient time period to kill the bacteria to a point where the bacterial count is below accepted thresholds to reduce the risk of food-borne illness. This is typically done by heating the egg whites to approximately 134° F. for a predetermined period of time, typically 3-5 minutes. Those skilled in the art will appreciate that heating the egg whites to a temperature of about 140° F. or higher has a tendency to cook the egg whites and may reduce the bioavailability of the protein. It will be appreciated that if egg whites are obtained in step 10 by purchasing the egg whites from an egg processor, then the egg whites may be pasteurized by the egg processor prior to step 10. Under such circumstances step 20 may be omitted.

In accordance with one aspect of the invention, it has been found that the end product may be improved by pasteurizing the egg whites, step 20, for between about 3 and 5 minutes at a temperature of between about 137° F. and just below about 140° F., and desirably at about 138° F. provides improved product characteristics, such as flowability, consistency, and/or increased shelf life, etc.

Once the egg whites have been pasteurized, step 20, a subsequent step 30 may include adding a flavoring to the egg whites as indicated at 30. The flavoring may include, for example, chocolate, vanilla, French vanilla, strawberry, strawberry crème, chocolate/banana, chocolate/caramel, mocha, espresso, etc. The flavoring may be added in powdered or liquid form and may form a small percentage of the overall beverage. For example, it is currently believed that a range of about 0.1-3.0 percent flavoring by weight is desirable. A representative amount of flavoring may be, for example, about 5-16 pounds of Ghirardelli unsweetened chocolate powder added to about 900-1000 pounds of egg whites, with between about 8 and 9 pounds working particularly well. Other flavorings may use greater or smaller amounts.

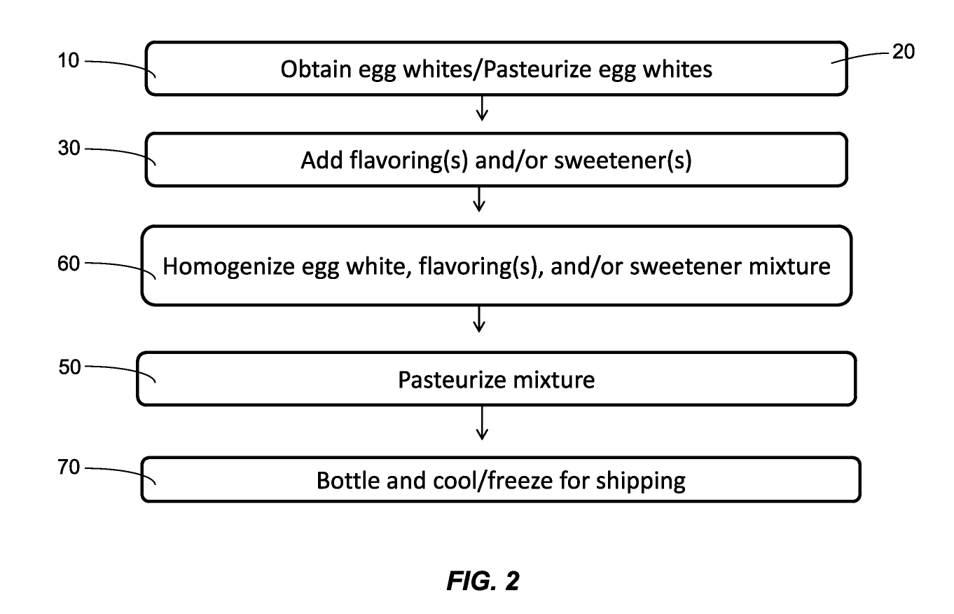

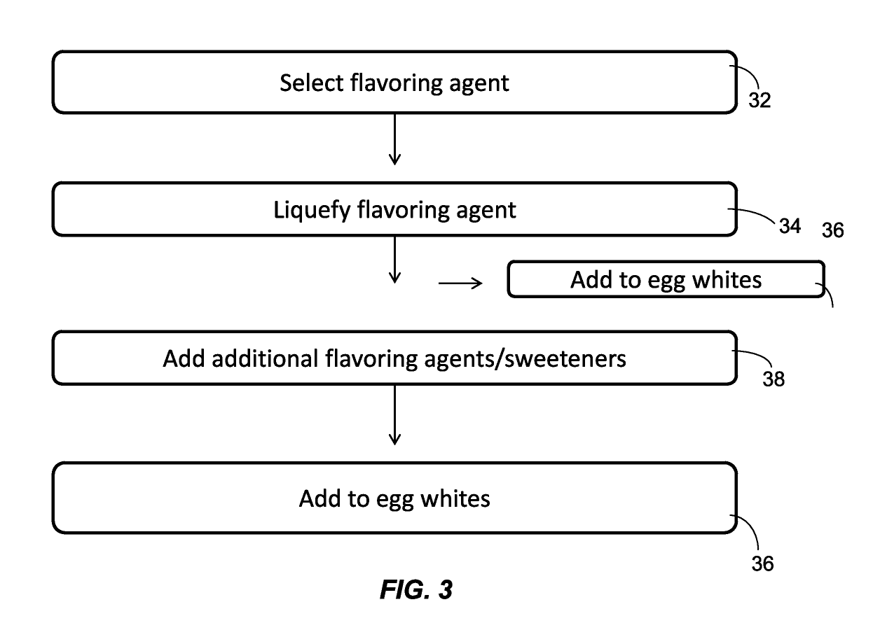

In accordance with one aspect of the present invention, it has been found desirable to select a flavoring agent and form the flavoring into a liquid or paste prior to mixing with the egg whites as indicated at steps 32 and 34 in FIG. 3. With some flavoring agents, mixing powdered flavoring into the egg whites may leave clumps of flavoring agent even after the mixture of egg whites and flavoring agent is passed through a homogenizer (See e.g. step 60, FIG. 2). Thus, for example, a given quantity, e.g. about 5-16 pounds of cocoa powder (such as Ghirardelli unsweetened cocoa powder) can be liquefied using about 10-50 cups of water. The mixture is then added to about 900-1000 pounds of egg whites. It has been found that using unsweetened cocoa powder provides a superior end result as compared to products containing cocoa-butter, and reduces the risk of bacterial growth in the resulting protein beverage. (It will be appreciated that step 34 in FIG. 3 can be omitted if the flavoring agent selected in step 32 is a liquid flavoring).

The flavoring agent may be added to the egg whites as shown at step 36 in FIG. 3, or it may be mixed first with one or more sweeteners in step 38. It will also be appreciated that multiple flavoring agents can be selected at step 32 and combined into a single liquid or paste prior to addition to the egg whites at step 36. Alternatively, flavoring(s) and/or sweetener(s) may be added to the egg whites in sequential order.

While many people enjoy eating egg whites when used in traditional cooking methods, they generally are not of a flavor which people wish to drink uncooked. The addition of flavoring(s) and/or sweetener(s) help make the egg whites palatable to the taste such that a consumer may find it similar to that of drinking chocolate milk or other flavored milks. The sweetener can be any of a variety of sweeteners including sugar and sugar substitutes. In accordance with one aspect of the invention, a manufactured sweetener such as sucralose or acesulfame potassium (ace-k), which is nearly 200 times as sweet as sugar, or a combination thereof is added to the egg whites. In normal usage about 60-200 grams of ace-k is added to approximately 1,000 pounds of egg whites. In the alternative approximately 15-100 grams of sucralose may be used for about 1,000 pounds of egg whites. A mixture of sucralose and ace-k may also be used. Other substances may be added to the mixture, such as thickening agents and/or stabilizers which may be used for product stability and feel. For example, gums such as guar gum, xantham gum, konjac gum, TICALOID 750 (sold by TIC GUMS, Inc., 10552 Philadelphia Rd, White Marsh, Md. 21162) and stabilizers, such as XC 8444 (sold by TIC GUMS, Inc., 10552 Philadelphia Rd, White Marsh, Md. 21162) may be added to the mixture.

In accordance with one aspect of the present invention, the protein beverage includes at least about 90 percent egg white by weight. It is more desirable to have the egg white be at least about 95 percent of the beverage by weight. In a currently manufactured embodiment, the egg whites are about 97 to 99 percent by weight of the protein beverage (depending on which flavoring is added), and the flavoring, sweeteners and gums together amount to less than about 1-3 percent by weight. For example, vanilla may be added at about 12-25 pounds per approximately 1000 pounds of egg white, while some chocolates may only require about 5-9 pounds. Thus, the final egg white percentage by weight may be about 97, 98, or 99 percent by weight depending on the flavoring used.

In addition to flavorings and sweeteners, a substance such as a biological enhancing agents may also be included as indicated at 40 (FIG. 1). Biological enhancing agents may include caffeine, taurine (2-aminoethanesulfonic acid), other stimulants, etc., which can be added to help promote physical activity with use of the product.

The product may then be bottled or may be re-pasteurized if desired. It has been found in accordance with the present invention that re-pasteurizing the product may substantially improve shelf life and reduce the risk of bacterial contamination. (Reference to bottled or bottling is intended to cover various types of packaging, including bottles, drink boxes and other containers). This may be done at approximately 134° F. as is commonly done. It is believed to be desirable, however, to re-pasteurize the mixture at about 138° F.

Turning now to FIG. 2, there is shown an alternate embodiment of a method in accordance with the present invention. The steps of obtaining the egg whites 10 and pasteurizing the egg whites 20 have been consolidated. These two steps may be performed separately, or may be accomplished in a single step—such as by purchasing egg whites which have already been pasteurized. The U.S. Department of Agriculture usually requires egg whites to be pasteurized prior to sale.

The next step 30 may include adding flavoring(s) and/or sweetener(s) as explained above and/or as shown in FIG. 3. The flavoring(s) and/or sweetener(s) typically make the mixture more palatable to the taste.

In accordance with one aspect of the invention, once the flavoring(s) and/or sweetener(s) are added to the egg whites, the mixture may then be subjected to a homogenizer, as shown at step 60. The homogenizer helps to ensure consistency and flowability of the egg white/flavoring/sweetener mixture. This results in an egg white based mixture which is very smooth and has a consistency more similar to that of milk. For many people, such a consistency is easier to drink than conventional egg whites.

Following homogenization, the mixture of egg white and flavoring(s) and/or sweetener(s) may be bottled as shown at 70. The bottles contain the protein beverage comprising liquid egg whites and may be shipped as such. However, it is preferred to freeze the bottles of the ready to drink protein beverage for transport. It will be appreciated that step 60 may not be necessary, i.e. the protein beverage may be bottled without processing the egg white/flavoring/sweetener mixture through the homogenizer.

In accordance with one aspect of the invention, however, it has been found desirable to re-pasteurize the mixture, as shown at 50, after addition of any flavoring(s) and/or sweetener(s). This may be done by heating the mixture to at least approximately 134° F. for between about 3 to 5 minutes. It is desirable in accordance with one aspect of the invention, to heat the mixture to between approximately 137° F. and just below 140° F. for about 3 to 5 minutes, with 138° F. being desirable.

The second pasteurization helps to ensure that any remaining bacterial growth is limited in the protein beverage which now includes flavoring(s) and/or sweetener(s). By keeping fats virtually non-existent, and by pasteurizing the mixture, the beverage is more resistant to spoiling.

Once the second pasteurization has taken place, the mixture is bottled. The bottles may be kept frozen for up to a year. Once thawed the bottles may be stored in a refrigerator, preferably below about 38°. In accordance with one aspect of the invention, it has been found that the ready to drink beverage can be held in a refrigerated state for up to about 30-90 days without bacterial counts passing accepted standards. This is far longer than milk and many other dairy or egg based protein drinks can be safely stored.

Thus, there is disclosed an improved protein beverage and method of manufacture. Those skilled in the art will appreciate numerous modifications which can be made to the composition and methods discussed above without departing from the scope and spirit of the invention. The appended claims are intended to cover such modifications.

Additionally, while the present disclosure has provided various methods of manufacturing the product, it will be appreciated that the various steps need not be performed in the precise order and that steps discussed in association with one embodiment of the method could be used in the other and vice-versa.

What is claimed is:

1. A method for making a beverage comprising:
obtaining egg whites;
adding at least one of a flavoring and a sweetener to the egg whites to form a mixture; and
pasteurizing the mixture.

2. The method according to claim 1, further comprising the step of pasteurizing the egg whites prior to adding the at least one of the flavoring and the sweetener.

3. The method according to claim 1, further comprising the step of homogenizing the mixture.

4. The method according to claim 3, wherein the method comprises homogenizing the mixture prior to pasteurizing the mixture.

5. The method according to claim 1, further comprising the step of adding a biological enhancing agent to the mixture.

6. The method according to claim 1, wherein the method comprises pasteurizing the mixture at between about 137° F. and about 140° F.

7. The method according to claim 6, wherein the method further comprises pasteurizing the mixture between about 137° F. and about 140° F. prior to adding at least one of a flavoring and a sweetener.

8. The method according to claim 1, wherein the method comprises adding a flavoring comprising chocolate, and an artificial sweetener to the egg whites.

9. The method according to claim 1, wherein the method comprises adding a non-fat liquid flavoring to the egg whites.

10. The method according to claim 1, further comprising the step of liquefying the flavoring prior to adding the flavoring to the egg whites.

11. A protein beverage comprising:
at least about 90 percent liquid egg whites by weight;
at least one flavoring; and
at least one sweetener, the sweetener and flavoring comprising less than about 10 percent of the beverage by weight.

12. The protein beverage of claim 11, wherein the beverage comprises at least about 95 percent egg whites by weight.

13. The protein beverage of claim 11, wherein the beverage comprises at least about 97 percent egg whites by weight and wherein the flavoring and sweetener comprise less than about 3 percent by weight.

14. The protein beverage of claim 11, wherein the flavoring comprises a chocolate and wherein the sweetener comprises an artificial sweetener.

15. The protein beverage of claim 11, wherein the egg whites, flavoring, and sweetener comprise a substantially homogenous protein beverage.

16. The protein beverage of claim 11, wherein the egg whites have been pasteurized prior to addition of the flavoring and the sweetener, and wherein the mixture of egg whites, flavoring, and sweetener are subjected to pasteurization.

17. The protein beverage of claim 11, wherein the protein beverage has a shelf life of at least about 30 to about 90 days.

18. The protein beverage of claim 11, further comprising at least one other substance in addition to the flavoring and the sweetener.

19. A ready to drink egg-based protein beverage comprising:
at least about 97 percent liquid egg whites by weight;
at least one liquid flavoring;
at least one sweetener; and
at least one of a thickening agent or stabilizer;
wherein the at least one flavoring, the at least one sweetener, and the at least one of a thickening agent or stabilizer comprises less than about 3 percent by weight of the protein beverage;
wherein the at least one flavoring, the at least one sweetener, and the at least one of a thickening agent or stabilizer have been added to the egg whites and processed in a homogenizer to form a substantially homogenous protein beverage that is then pasteurized prior to bottling.

20. The ready to drink egg-based protein beverage of claim 19, wherein the protein beverage has a shelf life of at least about 30 to about 90 days.
